(19) United States
(12) Patent Application Publication
(10) Pub. No.: US 2006/0118373 A1
(43) Pub. Date: Jun. 8, 2006

(54) Fixing arrangemenrt for a spring and/or damping element to a hollow support on a motor vehicle chassis

(76) Inventors: Olivier Birkwald, Holzgerlingen (DE); Joerg Sikorski, Sindelfingen (DE); Jens Weber, Stuttgart (DE)

Correspondence Address: CROWELL & MORING LLP;INTELLECTUAL PROPERTY GROUP, P.O. BOX 14300, WASHINGTON, DC, 20044-4300, US

(21) Appl. No.: 10/522,107

(22) PCT Filed: Jul. 5, 2003
(86) PCT No.: PCT/EP03/07213

§ 371 Date: Sep. 7, 2005

(30) Foreign Application Priority Data
Jul. 25, 2002 (DE) 102 33 826.4

(51) Int. Cl. B60G 7/02; B62D 17/00; F16F 9/00

(52) U.S. Cl. 188/315; 280/86.752; 280/86.75

(57) ABSTRACT

A fixing arrangement is provided for fixing a spring and/or damping element to a continuous hollow member of a motor vehicle body, into the lower flange of which a through-opening for the spring and/or damping element is let. The spring and/or damping element fixes a wheel suspension member of the motor vehicle to the hollow member by way of a load-distributing support. In order to support a longer spring and/or damping element against the hollow member of the motor vehicle body without increasing the distance from the wheel suspension member, the spring and/or damping element passes right through the hollow member and extends upwards from the upper flange of the hollow member. The spring and/or damping element is supported against the upper flange of the hollow member by a radially protruding socket. An adapter plate, which, when fitted, is fastened to the socket with a bracing and separating effect, is supported on the lower flange of the hollow member.

### BACKGROUND AND SUMMARY OF THE INVENTION

This invention relates to the fixing arrangement for fixing a spring and/or damping element to a hollow member of a motor vehicle body.

Each of U.S. Pat. Nos. 2,806,713 and 2,314,505 discloses a fixing arrangement for fixing a spring and/or damping element to a continuous hollow member of a motor vehicle body and in which a though-opening for the spring and/or damping element is let into a lower flange of the hollow member. In each of these cases the spring and/or damping element passes right through the hollow member and extends upwards out of the upper flange of the hollow member. A damper dome, which is supported on the hollow member by means of a radially protruding socket, is fixed to the upper flange as load-distributing support.

German document DE 198 27 864 C1, furthermore, discloses a fixing arrangement, in which a through-opening, through which an upper end of a spring element projects into the hollow member, is let into the lower flange of the hollow member. The spring element serves to fix a wheel suspension member of the motor vehicle to the hollow member by way of a load-distributing support in the form of a damper dome. A disadvantage with this known fixing arrangement is that the distance between the wheel suspension member and the hollow member of the body is not susceptible to any enlargement, for example in order that a longer spring and/or damping element may be arranged between them.

The object of the invention is to create a fixing arrangement of the type stated in the introductory part, by means of which the spring and/or damping element can be supported more rigidly and more stably on the hollow member of the motor vehicle body.

According to the invention this object is achieved by the features of the main claim.

Advantageous developments of the invention are set forth in the other claims.

In the fixing arrangement according to the invention the spring and/or damping element passes right through the hollow member, so that it extends upwards from the upper flange of the hollow member and advantageously occupies the overall space generally available above the hollow member. At the same time the spring and/or damping element is supported on the upper flange of the hollow member by means of a radially protruding socket. This embodiment of the fixing arrangement means that a longer spring and/or damping element extending upwards out of the hollow member and having a correspondingly large effective length (spring/damper travel) can be used without the need to modify the distance between the wheel suspension member and the hollow member. A space-saving fixing arrangement is produced, which nevertheless permits a relatively large spring/damper travel of the spring and/or damping element.

An especially rigid and stable attachment of the spring and/or damping element is obtained if an adapter plate, which when fitted is fastened to the socket of the spring and/or damping element with bracing and separating effect, is supported on the lower flange of the hollow member.

A further increase in rigidity in the area of the attachment of the spring and/or damping element to the hollow member is ensured in that a cage, which connects the upper flange and lower flange of the hollow member together whilst reinforcing the member cross-section, is provided between the socket and the adapter plate inside the hollow member.

In particular, the cage exercises an effect on the buckling rigidity of the hollow member if the cage is arranged in the area of an offset of the hollow member—for example, in proximity to the wheel housing or the axle of the motor vehicle.

Further advantages, features and details of the invention will be apparent from the following description of a preferred exemplary embodiment and from the drawings.

### BRIEF DESCRIPTION OF THE DRAWINGS

FIG. 1 shows a perspective view of the rear of a self-supporting vehicle body having the two spring and damping elements arranged according to the invention;

FIG. 2 shows a perspective, partial view of the fixing arrangement according to the invention for fixing the spring and/or damping element to a body rear side member;

FIG. 3 shows a perspective view of the fixing arrangement according to FIG. 2, the side member being shown cut away;

FIG. 4 shows a perspective exploded view of the fixing arrangement according to FIGS. 2 and 3 with a cage arranged inside the hollow member;

FIG. 5 shows a perspective view of the cage visible in FIGS. 3 and 4; and

Figure shows a perspective view of an adapter plate for the fixing arrangement, the plate when fitted being supported against the lower flange of the hollow member.

### DETAILED DESCRIPTION OF THE INVENTION

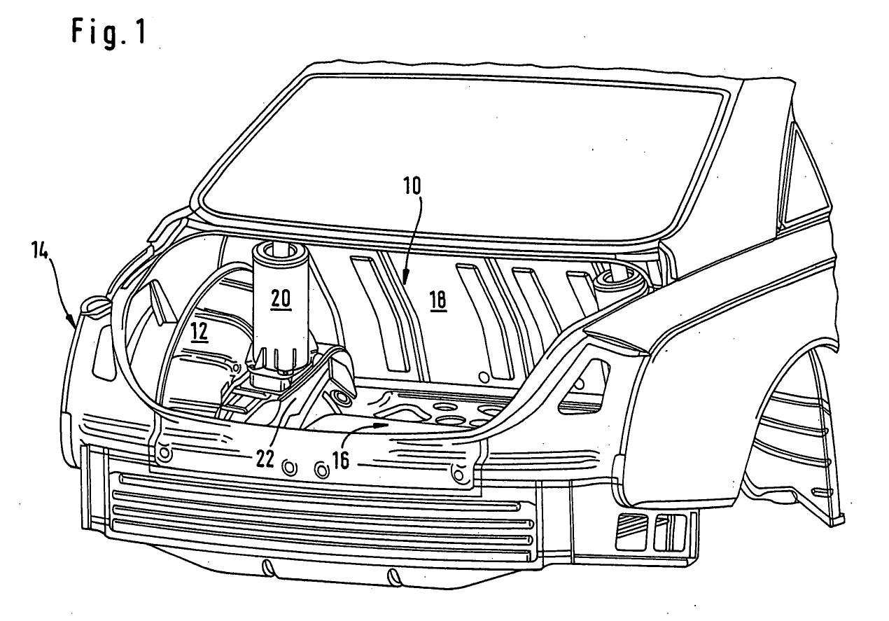

FIG. 1 shows a perspective view of the rear of a self-supporting motor vehicle body having a trunk 10, which is defined laterally by side walls 14 provided with wheel housings 12, at the bottom by a trunk floor 16 and at the front by a rear wall 18. A spring and damping element 20 of the pneumatic suspension of the motor vehicle is arranged inside each of the wheel housings 12, the elements each being fixed to an assigned rear side member 22 of the motor vehicle, as described further below.

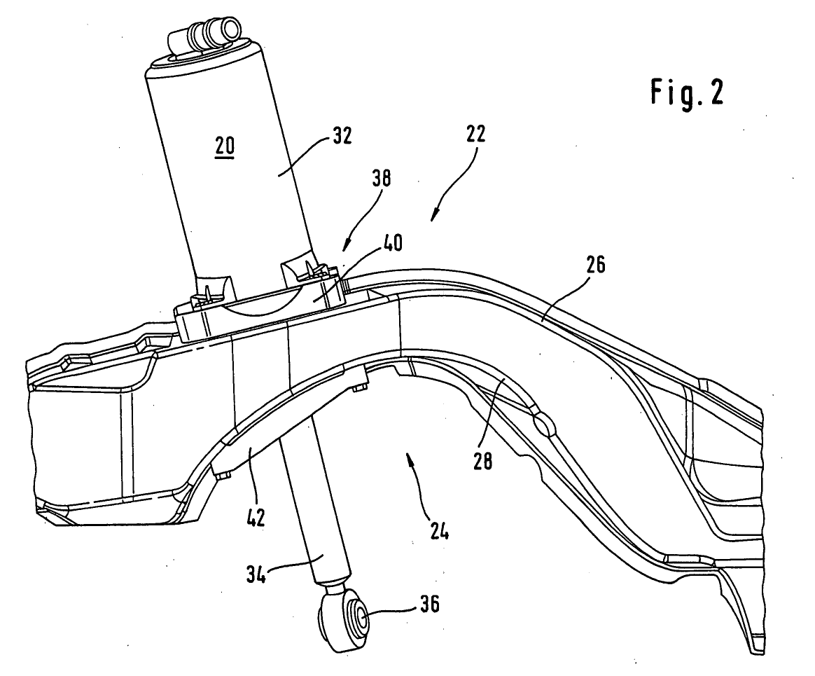

FIG. 2 shows a perspective, partial view of the fixing arrangement for fixing the spring and damping element 20 to the body rear side member 22. The side member 22 here takes the form of a continuous hollow member, which is composed, for example, of sheet metal shells welded together. The side member 22 here has an offset 24 in the area of the wheel housing 12 or a rear axle of the motor vehicle, not drawn in here.

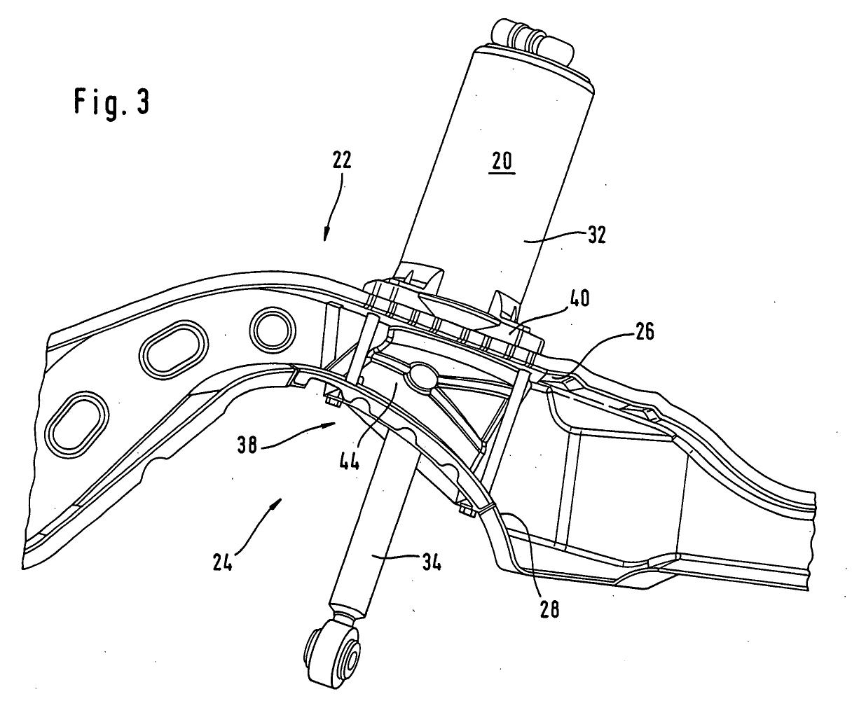

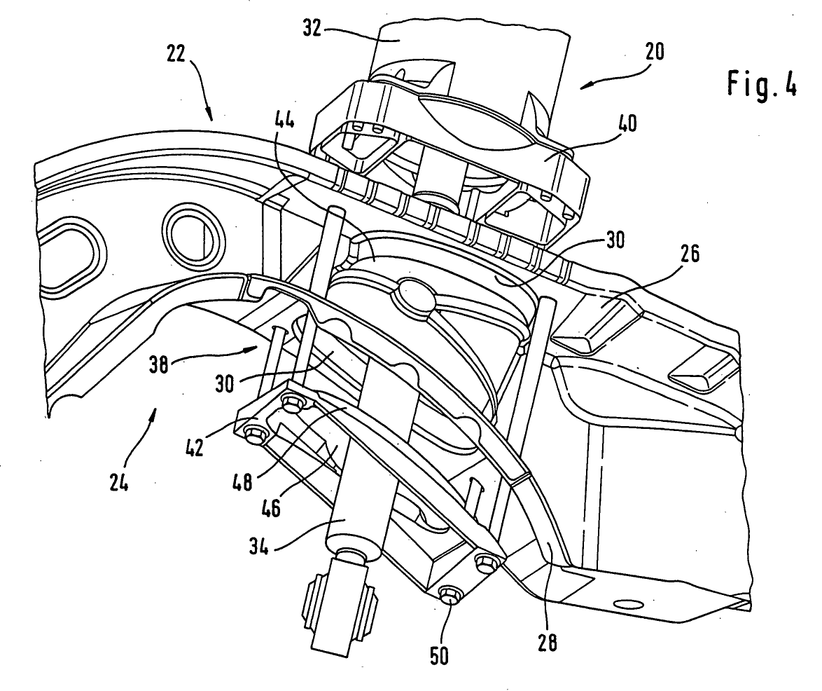

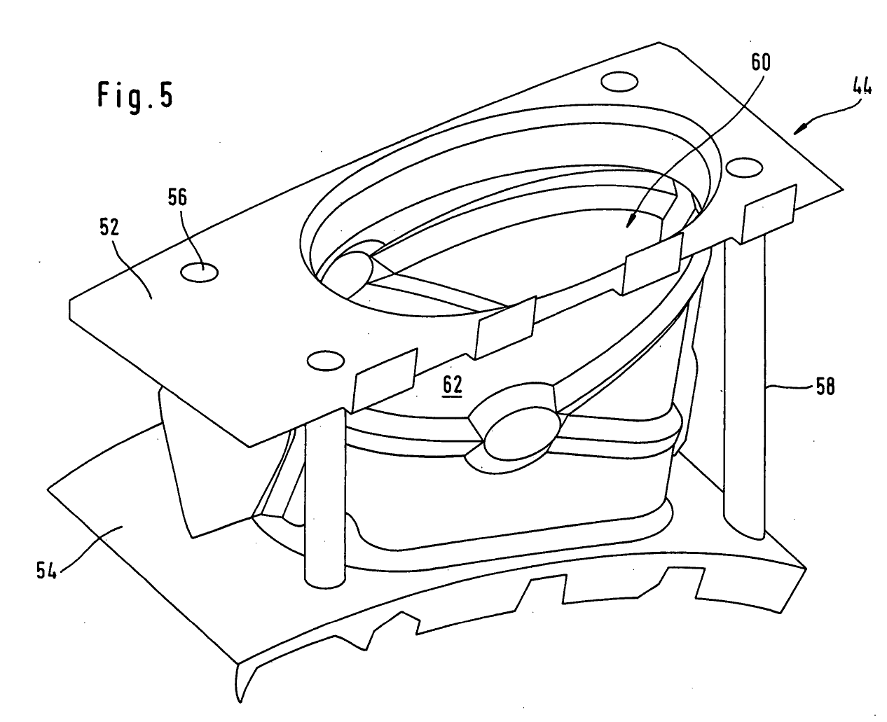

Looking at FIG. 2 in conjunction with FIGS. 3 and 4, in which the fixing arrangement according to FIG. 2 is represented in a perspective view with the side member 22 cut away, and in a perspective exploded view with the side member 22 cut away, the details of the fixing of the spring and damping element 20 on the rear side member 22 can clearly be seen. A through-opening 30 (FIG. 4) for the spring and damping element 20 is let into an upper flange 26 and a lower flange 28 of the hollow member 22 respectively, so that the element passes right through the hollow member 22. The part extending upwards above the hollow member 22 comprises a domed cylindrical housing 32, inside which a coil spring (not shown) and a damper are arranged. A wheel suspension member (not shown) is articulated by way of a bearing eye 36 on a coupling bar 34 of the spring and damping element 20, the bar passing right through the hollow member 22.

The spring and damping element 20 is fixed to the side member 22 by way of a load-distributing support 38, which essentially comprises a radially protruding socket 40, integrally joined to the cylindrical housing 32, an adapter plate 42 and a cage 44 (FIGS. 3 to 6) arranged inside the side member 22—between socket 40 and adapter plate 42. The cylindrical housing 32 is here composed of cast metal. The radially protruding socket 40 is made to conform to the shape of the upper flange so that, when fitted, the spring and damping element 20 is supported against the upper flange 26 of the hollow member 22 by way of the socket 40. The adapter plate 42 is made to conform to the shape of the lower flange 28 and when fitted is supported against this, the adapter plate 42 having a central opening 46. The opening 46 is defined by an upwardly extending collar 48 (FIGS. 4, 6), which can be inserted into the through-opening 30 in the lower flange 28. When fitted, the socket 40 and the adapter plate 42 are fastened together by four bolted connections 50, being braced and separated from one another by the cage 44, as explained further below.

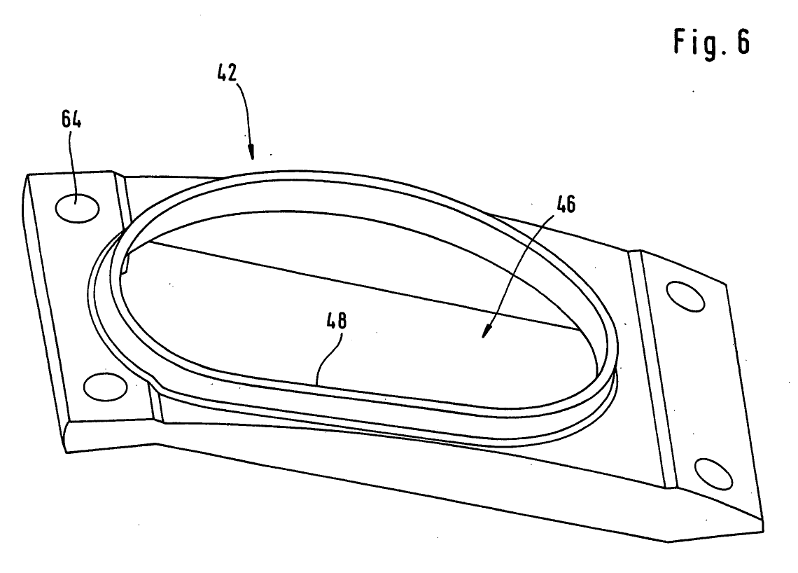

FIG. 5 shows a perspective view of the cage 44 which is visible in FIGS. 3 and 4 and which is designed as a separately preassembled unit. The cage comprises an upper plate 52 and a lower plate 54, which run parallel to the assigned upper flange 26 and lower flange 28 of the hollow member 22, and which when fitted bear against these. The cage 44 thereby connects the upper flange 26 and lower flange 28 of the hollow member 22 together whilst reinforcing the member cross-section. Since the upper flange 26 and lower flange 28 of the hollow member 22 converge at an acute angle in the area where the cage 44 is arranged, the upper plate 52 and lower plate 54 extend at an identical acute angle to one another. Four holes 56, between which four screw sleeves 58 extend, are let into both the upper plate 52 and the lower plate 54 respectively. The sleeves 58 are connected to the upper plate 52 and the lower plate 54 by a joined connection, in particular a welded connection. The upper plate 52 and lower plate 54 each comprise an opening 60, the shape of the openings being designed to match the through-opening 30 in the upper flange 26 and lower flange 28 of the hollow member 22. A tubular sleeve 62, by way of which the upper plate 52 and lower plate 54 of the cage 44 are connected together in addition to the screw sleeves 58, is likewise designed to match this shape of the openings 30, 60. The upper plate 52 and lower plate 54 are preferably connected to the tubular sleeve 62 by a joined connection, in particular a welded connection. In the exemplary embodiment shown here, both the upper plate 52 and lower plate 54 and the tubular sleeve 62 are made of a sheet metal. In order to create an especially rigid, separated bracing between the socket 40 on the upper flange 26 and the adapter plate 42 on the lower flange 28 of the hollow member 22, the upper plate 52 and lower plate 54 together with the tubular sleeve 62 of the cage 44 are provided with beads, ribs or similar reinforcements.

FIG. 6 shows a perspective view of the adapter plate 42 with the opening 46 defined by the upwardly projecting collar 48. Four holes 64, through which the bolted connections 50 pass, are let into the adapter plate 42.

1-10. (canceled)

11. A fixing arrangement for fixing a spring and/or damping element to a continuous hollow member of a motor vehicle body of a motor vehicle, a through-opening for the spring and/or damping element being let into a lower flange of the hollow member, the spring and/or damping element fixing a wheel suspension member of the motor vehicle to the hollow member by way of a load-distributing support, the spring and/or damping element passing right through the hollow member and extending upwards from an upper flange of the hollow member, the load-distributing support comprising:
a radially protruding socket by which the spring and/or damping unit is supported against the upper flange of the hollow member, and
an adapter plate, which when fitted is fastened to the socket with a bracing and separating effect, supported on the lower flange of the hollow member.

12. The fixing arrangement as claimed in claim 11, wherein a cage, which connects the upper flange and the lower flange of the hollow member together while reinforcing the member cross-section, is provided between the socket and the plate inside the hollow member.

13. The fixing arrangement as claimed in claim 12, wherein the upper flange and the lower flange of the hollow member converge at an acute angle in an area where the cage is arranged.

14. The fixing arrangement as claimed in claim 12, wherein the cage has a lower plate and an upper plate, and wherein the lower plate and the upper plate of the cage run approximately parallel to the lower flange and the upper flange of the hollow member.

15. The fixing arrangement as claimed in claim 14, wherein the lower plate and the upper plate of the cage are connected together by way of a tubular sleeve.

16. The fixing arrangement as claimed in claim 14, wherein the lower plate and the upper plate of the cage are connected together by way of multiple screw sleeves.

17. The fixing arrangement as claimed in claim 12, wherein the cage takes the form of a preassembled unit.

18. The fixing arrangement as claimed in claim 12, wherein the cage is arranged in an area of an offset of the hollow member.

19. The fixing arrangement as claimed in claim 18, wherein the hollow member is an offset side member in an area of a wheel housing.
